(19) United States
(12) Patent Application Publication
(10) Pub. No.: US 2013/0056037 A1
(43) Pub. Date: Mar. 7, 2013

(54) APPARATUS FOR AND METHOD OF PROCESSING SUBSTRATE

(71) Applicants: Kozo TERASHIMA, Kyoto-shi (JP); Akihiro HOSOKAWA, Kyoto-shi (JP); Keiji MAGARA, Kyoto-shi (JP)

(72) Inventors: Kozo TERASHIMA, Kyoto-shi (JP); Akihiro HOSOKAWA, Kyoto-shi (JP); Keiji MAGARA, Kyoto-shi (JP)

(21) Appl. No.: 13/556,674

(22) Filed: Jul. 24, 2012

(30) Foreign Application Priority Data
Sep. 6, 2011 (JP) 2011-193770
May 14, 2012 (JP) 2012-110928

(51) Int. Cl. B08B 3/04; F03B 11/02

(52) U.S. Cl. 134/34; 134/184; 137/561 R

(57) ABSTRACT

A processing unit includes third discharge nozzles. Each of the third discharge nozzles discharges a processing liquid toward a lower tapered surface of a groove of a V-shaped cross-sectional configuration formed in a side wall of an inner bath. This forms relatively low-speed liquid flows within the inner bath. The processing unit further includes plate-like members. The plate-like members block upward ones of the liquid flows discharged from the third discharge nozzles and impinging upon the lower tapered surfaces of the inner bath. This achieves the efficient replacement of the processing liquid without disturbing upward flows of the processing liquid within the inner bath. Thus, the processing liquid stored in the processing bath is efficiently replaced with another processing liquid without disturbing the upward flows of the processing liquid within the processing bath.

### BACKGROUND OF THE INVENTION

1. Field of the Invention

The present invention relates to a substrate processing apparatus and a substrate processing method for performing processes including a cleaning process, an etching process and the like upon planar substrates such as semiconductor substrates, glass substrates for a liquid crystal display device, and glass substrates for a photomask by immersing the substrates in a processing liquid.

2. Description of the Background Art

In the process of manufacturing substrates, a substrate processing apparatus is used which processes the substrates by immersing the substrates in a processing liquid stored in a processing bath. As the process proceeds, it is necessary for such a substrate processing apparatus to replace the processing liquid stored in the processing bath with another processing liquid and to drain the processing liquid containing particles and the like coming off the substrates. To this end, a method has been employed in which a discharge nozzle for discharging the processing liquid is provided near the bottom of the processing bath, and in which the processing liquid is discharged from the discharge nozzle to overflow from the top of the processing bath, whereby the replacement of the processing liquid is achieved.

For efficient replacement of the processing liquid stored in the processing bath, it is desirable to configure the substrate processing apparatus so that the processing liquid during the replacement does not remain locally because of the generation of an eddy and a turbulent flow but flows uniformly upwardly within the processing bath. In a substrate processing apparatus as disclosed, for example, in Japanese Patent Application Laid-Open No. 2009-81240, opposite side walls of a processing bath near the lower end thereof are provided with respective grooves of a V-shaped cross-sectional configuration opening to (or facing toward) the inside of the processing bath. Discharge nozzles are provided within the respective grooves. The discharge nozzles discharge a processing liquid toward the lower tapered surfaces of the respective grooves of the V-shaped cross-sectional configuration. The processing liquid impinges upon the lower tapered surfaces to turn toward the inside of the processing bath while being diffused upwardly and downwardly by the lower tapered surfaces. The processing liquid which is decreased in speed of flow by impinging upon the lower tapered surfaces of the grooves of the V-shaped cross-sectional configuration is diffused upwardly and downwardly to flow toward the inside of the processing bath, whereby the speed of flow of the processing liquid is further decreased. Thus, the liquid in the processing bath is efficiently replaced in a lower part of the processing bath by the processing liquid diffused and decreased in speed of flow.

As shown in FIG. 1, a processing bath 503 disclosed in Japanese Patent Application Laid-Open No. 2009-81240 is configured such that a processing liquid is discharged from a nozzle 513 toward a lower tapered surface 517 of a groove 505 of a V-shaped cross-sectional configuration provided near a bottom portion 509 of a side wall 507. The discharged processing liquid impinges upon the lower tapered surface 517. This causes the processing liquid to decrease in speed of flow, and also to divide into a flow moving in an upward and rightward direction as indicated by an arrow B1 and a flow moving in a downward and leftward direction as indicated by an arrow B2.

The flow indicated by the arrow B2 moves along the inner surface of the bottom portion 509. The flow indicated by the arrow B2 impinges near the middle of the bottom portion 509 upon a flow of processing liquid discharged from another nozzle 513 provided similarly on the opposite side wall 507 and moving along the bottom portion 509. As a result, flows moving upwardly in the processing bath 503 are produced.

The flows moving upwardly in the processing bath 503 allow the efficient replacement of the processing liquid stored in the processing bath 503 and the efficient drainage of the processing liquid containing particles and the like coming off the substrates.

The flows of the processing liquid discharged from the nozzles 513 provided on the opposite side walls 507 of the processing bath 503, impinging near the middle of the bottom portion 509 upon each other, and moving upwardly in the processing bath 503 include a flow component directed from the middle of the processing bath 503 toward each of the side walls 507 as indicated by an arrow B4.

The flows of the processing liquid after the impingement upon the lower tapered surface 517 of the groove 505 include the flow indicated by the arrow B1 as well as the flow indicated by the arrow B2. The flow indicated by the arrow B1 which is directed in the upward and rightward direction impinges upon an upper tapered surface 515 of the groove 505 to change in direction, thereby becoming a flow directed toward the middle of the processing bath 503 as indicated by an arrow B3.

The flow indicated by the arrow B3 and the flow indicated by the arrow B4 impinge upon each other to decrease in speed locally near an upper portion of the groove 505, thereby forming a backwater and a local eddy. This might slightly decrease the efficiency of drainage and replacement of the processing liquid.

### SUMMARY OF THE INVENTION

It is therefore an object of the present invention to provide a substrate processing apparatus and a substrate processing method which are capable of causing a processing liquid to flow more uniformly upwardly within a processing bath during the replacement of the processing liquid, thereby further improving the efficiency of the replacement of the processing liquid stored within the processing bath with another processing liquid.

According to a first aspect of the present invention, a substrate processing apparatus comprises: a processing bath having side walls and a bottom wall for storing a processing liquid therein; a pair of recessed portions formed respectively in a pair of opposed ones of the side walls of the processing bath, the recessed portions being disposed near the bottom wall, each of the recessed portions having an opening facing toward the inside of the processing bath; a pair of discharge parts for discharging the processing liquid toward the inside of the recessed portions, respectively; and a pair of plate-like members coupling the vicinity of the upper ends of the recessed portions and the discharge parts, respectively.

In the substrate processing apparatus according to the first aspect, the processing liquid discharged from the discharge parts impinges upon the recessed portions formed in the side walls to divide into upward and downward flows. The upward flows of the processing liquid are blocked by the plate-like members. This prevents the processing liquid from forming a backwater and an eddy resulting from the impingement of a flow component directed outwardly from the middle of the processing bath within the processing bath above each of the recessed portions and a flow discharged from each of the discharge parts toward each of the recessed portions and directed upwardly toward the middle of the processing bath upon each other. As a result, the processing liquid flows more uniformly upwardly within the processing bath. Therefore, the efficient replacement of the processing liquid is achieved.

According to a second aspect of the present invention, a substrate processing apparatus comprises: a processing bath having side walls and a bottom wall for storing a processing liquid therein; a pair of recessed portions formed respectively in a pair of opposed ones of the side walls of the processing bath, the recessed portions being disposed near the bottom wall, each of the recessed portions having an opening facing toward the inside of the processing bath; and a pair of discharge parts for discharging the processing liquid toward the inside of the recessed portions, respectively, the discharge parts being in contact with or being buried in upper halves of the recessed portions, respectively.

In the substrate processing apparatus according to the second aspect, the processing liquid discharged from the discharge parts impinges upon the recessed portions formed in the side walls to divide into upward and downward flows. The upward flows of the processing liquid are blocked by bringing the discharge parts into contact with the recessed portions or by burying the discharge parts in the recessed portions. This prevents the processing liquid from forming a backwater and an eddy resulting from the impingement of a flow component directed outwardly from the middle of the processing bath within the processing bath above each of the recessed portions and a flow discharged from each of the discharge parts toward each of the recessed portions and directed upwardly toward the middle of the processing bath upon each other. As a result, the processing liquid flows more uniformly upwardly within the processing bath. Therefore, the efficient replacement of the processing liquid is achieved.

Preferably, each of the recessed portions is a groove of a V-shaped cross-sectional configuration opening to the inside of the processing bath, the groove being defined by a pair of tapered surfaces, and each of the discharge parts discharges the processing liquid toward a lower one of the tapered surfaces of the groove.

In the substrate processing apparatus thus configured, the processing liquid discharged from the discharge parts is changed in flow direction by the lower tapered surfaces toward the middle of the processing bath. The flows of the processing liquid from the two recessed portions opposed to each other, with the processing bath therebetween, impinge upon each other near the middle of the processing bath, and become slow flows rising within the processing bath. This achieves the efficient replacement of the processing liquid.

According to a third aspect of the present invention, a method of performing a process using a processing liquid on a substrate comprises the steps of: a) immersing a substrate in a processing liquid within a processing bath having a side wall and a bottom wall; and b) discharging the processing liquid from a nozzle toward a recessed portion provided in an inner surface of the side wall, while blocking a flow of the processing liquid directed from the inside of the recessed portion upwardly of the nozzle, thereby forming a flow of the processing liquid directed from the recessed portion toward the bottom wall.

In the apparatus and method according to the first to third aspects, the processing liquid are divided into upward and downward flows by the recessed portions formed in the side walls, and the upward flows of the processing liquid are blocked. Thus, the upward flows of the processing liquid within the processing bath become uniform flows without being disturbed. As a result, the efficiency of the replacement of the processing liquid is improved.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing flows of a processing liquid in a processing bath disclosed in Japanese Patent Application Laid-Open No. 2009-81240;

FIG. 2 is a perspective view showing a substrate processing apparatus according to one preferred embodiment of the present invention;

FIG. 3 is a view showing the configuration of a processing part;

FIG. 4 is a vertical sectional view of a processing bath in the processing part taken along a plane parallel to main surfaces of substrates;

FIG. 5 is a vertical sectional view of the processing bath in the processing part taken along a plane perpendicular to the main surfaces of the substrates;

FIG. 6 is a view showing a flow of the processing liquid when the processing liquid is discharged;

FIG. 7 is a view showing the configuration of a processing liquid supply part in the processing part;

FIGS. 8 and 9 are flow diagrams showing an operation of the processing part;

FIGS. 10 and 11 are schematic views showing flows of the processing liquid within an inner bath during the replacement of the processing liquid;

FIG. 12 is a view showing a result of a numerical simulation of flows of the processing liquid in the processing bath disclosed in Japanese Patent Application Laid-Open No. 2009-81240;

FIG. 13 is a view showing a result of a numerical simulation of flows of the processing liquid in the processing bath in the processing part according to the present invention; and

FIG. 14 is a view showing a modification of the processing part according to the present invention.

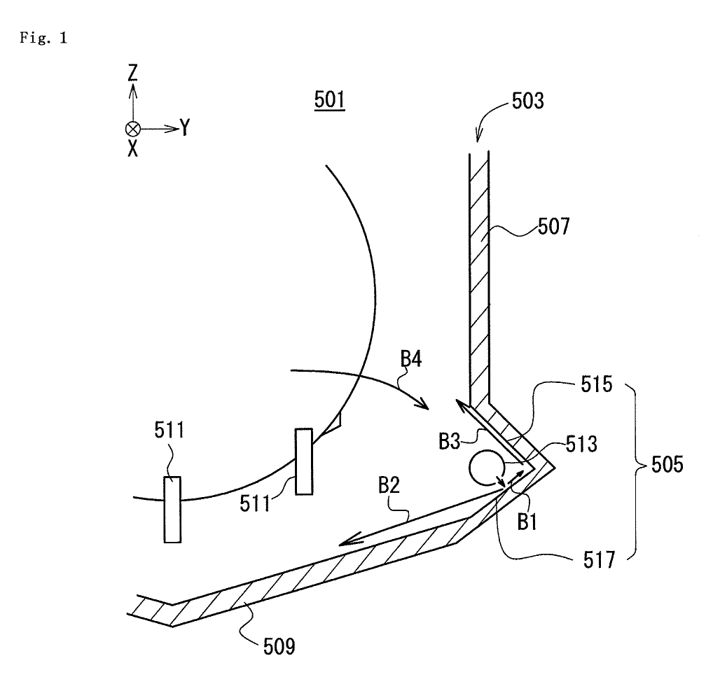

### DESCRIPTION OF THE PREFERRED EMBODIMENTS

### 1. Configuration of Substrate Processing Apparatus

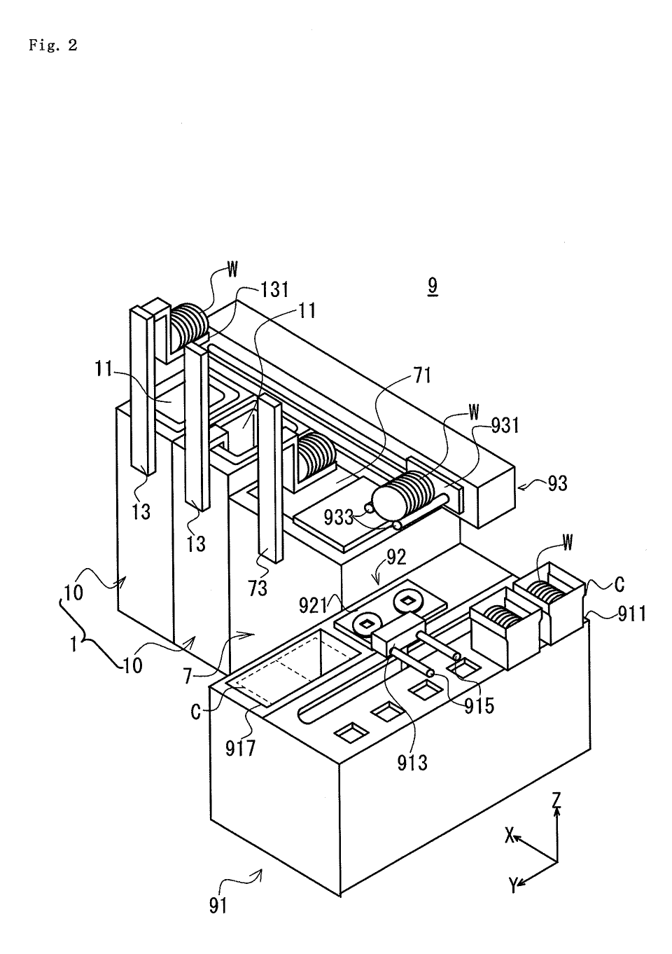

FIG. 2 is a schematic perspective view showing the configuration of a substrate processing apparatus 9 according to a preferred embodiment of the present invention. The substrate processing apparatus 9 is a batch-type substrate processing apparatus which performs a process using a chemical liquid and a rinsing liquid (referred to hereinafter as a “processing liquid”) upon a plurality of substrates such as semiconductor wafers.

The substrate processing apparatus 9 includes a processing part 1, a drying part 7, a cassette rest part 91, a substrate transfer part 92, and a substrate transport part 93. The processing part 1 performs a process using a processing liquid on substrates W. The drying part 7 dries the substrates W subjected to the process by the processing part 1. Cassettes C transported from the outside into the substrate processing apparatus 9 are placed on the cassette rest part 91. The substrate transfer part 92 transfers substrates W between a cassette C and the substrate transport part 93 to be described later. The substrate transport part 93 transports substrates W between the substrate transfer part 92, the processing part 1, and the drying part 7. An XYZ coordinate system is additionally shown in FIG. 2 for purposes of clarifying a directional relationship. For convenience of illustration, directions pointed by the arrows of the XYZ coordinate system shall be positive (+), and directions opposite from those pointed by the arrows of the XYZ coordinate system shall be negative (−).

The cassette rest part 91 is disposed on one edge of the substrate processing apparatus 9 (on an edge of the substrate processing apparatus 9 as seen in the negative X direction in FIG. 2). The cassette rest part 91 includes a cassette rest area 911, a cassette cleaning mechanism 917, and a cassette transfer robot 913. Cassettes C transported from the outside into the substrate processing apparatus 9 or to be transported from the substrate processing apparatus 9 to the outside are placed on the cassette rest area 911. The cassette cleaning mechanism 917 receives cassettes C therein to clean the cassettes C. The cassette transfer robot 913 transfers a cassette C between the cassette rest area 911, the cassette cleaning mechanism 917, and the substrate transfer part 92.

The cassette rest area 911 is disposed on one edge of the cassette rest part 91 (on an edge of the cassette rest part 91 as seen in the negative X direction in FIG. 2). The cassette rest area 911 is capable of placing a plurality of (in FIG. 2, six) cassettes C thereon. The cassette transfer robot 913 is disposed between the cassette rest area 911, and the cassette cleaning mechanism 917 and the substrate transfer part 92. The cassette transfer robot 913 includes cassette grasping arms 915 for grasping side surfaces of a cassette C. For transfer of a cassette C, the cassette transfer robot 913 is movable in the Y directions and in the Z directions, and is rotatable about an axis extending in the Z directions. The cassette cleaning mechanism 917 is disposed on the opposite side of the cassette transfer robot 913 from the cassette rest area 911. The cassette cleaning mechanism 917 is capable of receiving two cassettes C therein to clean the cassettes C.

The substrate transfer part 92 is disposed between the cassette rest part 91 and the drying part 7. The substrate transfer part 92 includes a cassette transfer table 921. The cassette transfer table 921 is capable of placing two cassettes C thereon. The cassette transfer table 921 is movable in the Y directions. A cassette C placed on the cassette transfer table 921 is rotatable about an axis extending in the Z directions. The cassette transfer table 921 is capable of thrusting all substrates W upwardly (in the positive Z direction) out of the two cassettes C by means of a thrust mechanism not shown to transfer the substrates W to the substrate transport part 93, and is capable of transferring substrates W held by the substrate transport part 93 to the two cassettes C.

The substrate transport part 93 is disposed over the substrate transfer part 92, the drying part 7, and the processing part 1. The substrate transport part 93 includes a main body part 931, and substrate holding members 933. The main body part 931 is movable in the X directions so as to transfer unprocessed substrates W from the substrate transfer part 92 to the processing part 1, to transfer processed substrates W from the processing part 1 to the drying part 7, and to transfer dried substrates W from the drying part 7 to the substrate transfer part 92. The substrate holding members 933 are a pair of columnar members extending in the positive Y direction from the main body part 931. The substrate holding members 933 hold the outer edges of substrates W so that the substrates W are held in an upright position.

The processing part 1 is disposed on the opposite edge of the substrate processing apparatus 9 from the cassette rest part 91 (on an edge of the substrate processing apparatus 9 as seen in the positive X direction in FIG. 2). The processing part 1 includes a plurality of (in the present preferred embodiment, two) processing units 10. Each of the processing units 10 includes a processing bath 11, and a lifter 13. The processing bath 11 stores a processing liquid therein to immerse substrates W in the processing liquid, thereby performing a process using the processing liquid on the substrates W. The lifter 13 receives substrates W from the substrate transport part 93 to immerse the substrates W into the processing liquid stored in the processing bath 11, and then transfers the processed substrates W to the substrate transport part 93. The lifter 13 is movable in the Z directions. This allows the transfer of the substrates W to and from the substrate transport part 93, the immersion of the substrates W into the liquid stored in the processing bath 11, and the lift of the substrates W out of the liquid. The configuration of the processing units 10 will be described in detail later.

The drying part 7 is disposed between the substrate transfer part 92 and the processing part 1. The drying part 7 includes a drying bath 71, and a lifter 73. The drying bath 71 receives substrates W therein to dry the substrates W. The lifter 73 transfers substrates W between the substrate transport part 93 and the drying bath 71. Various methods are used to dry the substrates W in the drying bath 71. Examples of the drying method include a process for spinning the substrates W at high speeds to dry the substrates W by making use of centrifugal force, a process for immersing the substrates W in a liquid such as isopropyl alcohol and then lifting the substrates W out of the liquid, and a process for blowing warm air at a high flow rate upon the surfaces of the substrates W.

Next, the operation of the substrate processing apparatus 9 will be described. A cassette C having unprocessed substrates W stored therein is transported from the outside into the substrate processing apparatus 9 by an automatic guided vehicle and the like. The cassette C is placed on the cassette rest area 911 of the cassette rest part 91. The cassette C having the unprocessed substrates W stored therein and placed on the cassette rest area 911 is transferred by the cassette transfer robot 913 to the cassette transfer table 921 of the substrate transfer part 92.

The cassette C transferred to the cassette transfer table 921 is rotated to an orientation such that all of the radial directions of the substrates W are parallel to an X-Z plane while all of the main surfaces of the substrates W stored in the cassette C are held in opposed relation. Thereafter, the substrates W are thrust upwardly by the thrust mechanism, and are transferred onto the substrate holding members 933 of the substrate transport part 93.

After the substrates W are transferred by the substrate transfer part 92 to the substrate transport part 93, the empty cassette C is transferred by the cassette transfer robot 913 to the cassette cleaning mechanism 917. The cassette C is cleaned by the cassette cleaning mechanism 917. The cleaned cassette C is transferred by the cassette transfer robot 913 again to the substrate transfer part 92.

The substrate transport part 93 which holds the unprocessed substrates W moves the substrates W to over the lifter 13 of one of the processing units 10 of the processing part 1. Subsequently, the substrate transport part 93 transfers the substrates W to the one lifter 13. The one processing unit 10 moves the lifter 13 downwardly (in the negative Z direction) to immerse the substrates W in the processing liquid stored in the processing bath 11, thereby performing the process on the substrates W. After the completion of the process, the lifter 13 moves upwardly (in the positive Z direction) to transfer the substrates W to the substrate transport part 93. The details on the operation of the processing units 10 will be described later.

The substrate transport part 93 which holds the processed substrates W moves the substrates W to over the drying part 7. Subsequently, the substrate transport part 93 transfers the substrates W to the lifter 73. The drying part 7 moves the lifter 73 downwardly to transfer the substrates W to a drying mechanism (not shown) in the drying bath 71, thereby performing a drying process on the substrates W. After the completion of the drying process of the substrates W, the lifter 73 holds the substrates W to transfer the substrates W to the substrate transport part 93.

The substrate transport part 93 which holds the substrates W subjected to the drying process moves to over the substrate transfer part 92. Subsequently, the substrate transport part 93 transfers the processed substrates W to the thrust mechanism of the cassette transfer table 921. The substrate transfer part 92 puts the substrates W placed on the thrust mechanism into a cassette C placed on the cassette transfer table 921.

The cassette C which receives the substrates W therein after being cleaned is transferred by the cassette transfer robot 913 to the cassette rest area 911. Thereafter, the cassette C is transported to the outside of the substrate processing apparatus 9.

In this preferred embodiment, the two processing units 10 are provided in the processing part 1, and the one drying bath 71 is provided in the drying part 7. However, the numbers of processing units and drying baths and the positions of the processing units and drying baths are not limited to those described above. The numbers of processing units and drying baths may be increased or decreased to achieve the required cycle time. Also, a plurality of substrate transport parts 93 may be provided. In such a case, while one of the substrate transport parts 93 transports a plurality of substrates W from one of the processing units 10 to the drying bath 71, the other or another substrate transport part 93 may be configured to transport another plurality of substrates W from the drying bath 71 to the substrate transfer part 92.

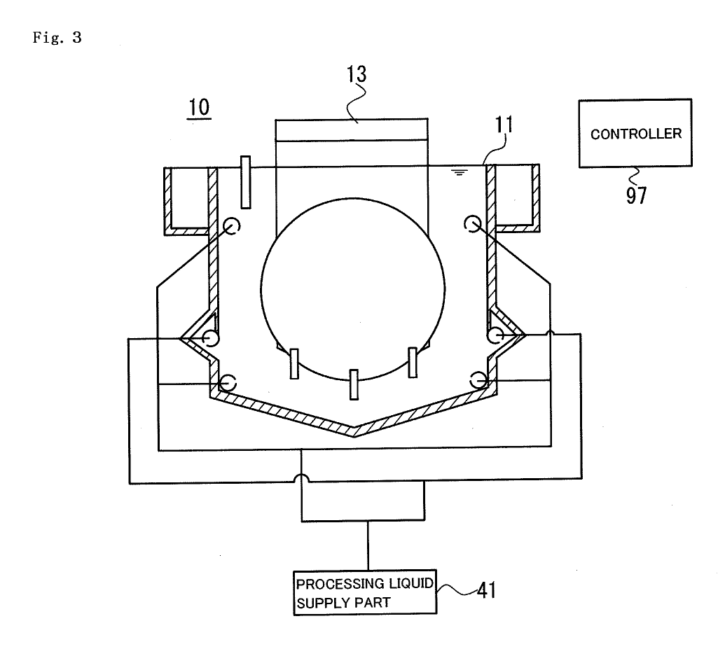

Next, the configuration of the processing units 10 will be described. Each of the processing units 10 is an apparatus which stores the processing liquid in the processing bath 11, and immerses substrates W in the stored processing liquid to perform a process on the substrates W. FIG. 3 is a schematic view of such a processing unit 10. The processing unit 10 includes the processing bath 11, a processing liquid supply part 41, the lifter 13, and a controller 97. The processing liquid is stored in the processing bath 11. The processing liquid supply part 41 supplies a plurality of processing liquids to the processing bath 11. The lifter 13 holds substrates W to immerse the substrates W in the processing liquid within the processing bath 11 and to thereafter lift the substrates W out of the processing liquid. The controller 97 controls the operation of the processing unit 10.

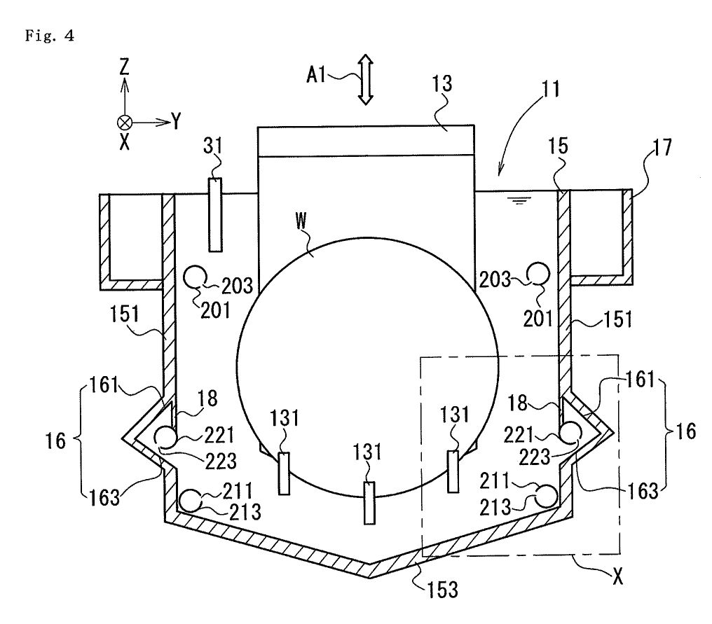

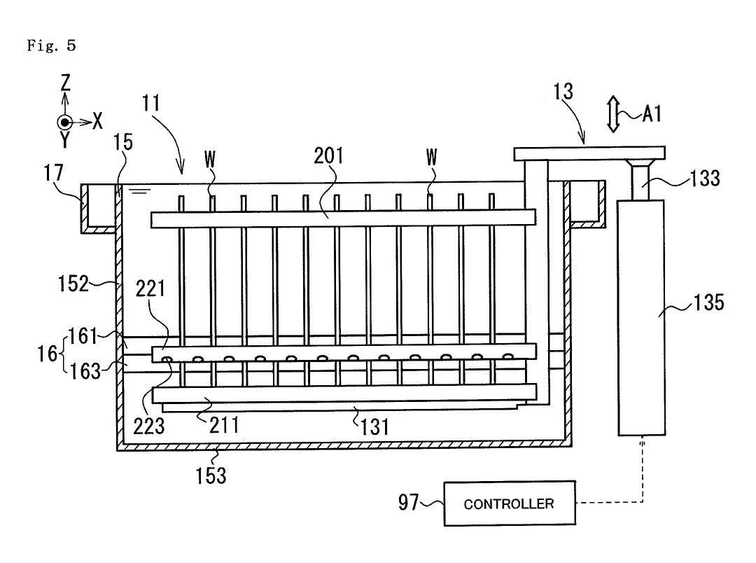

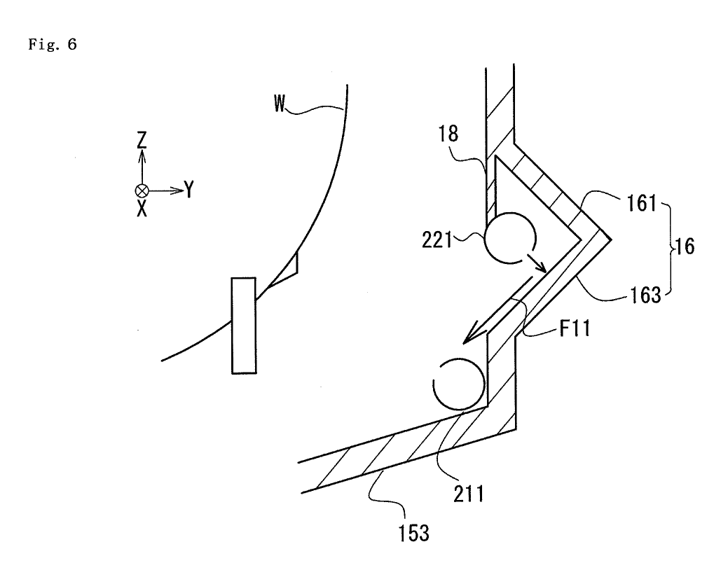

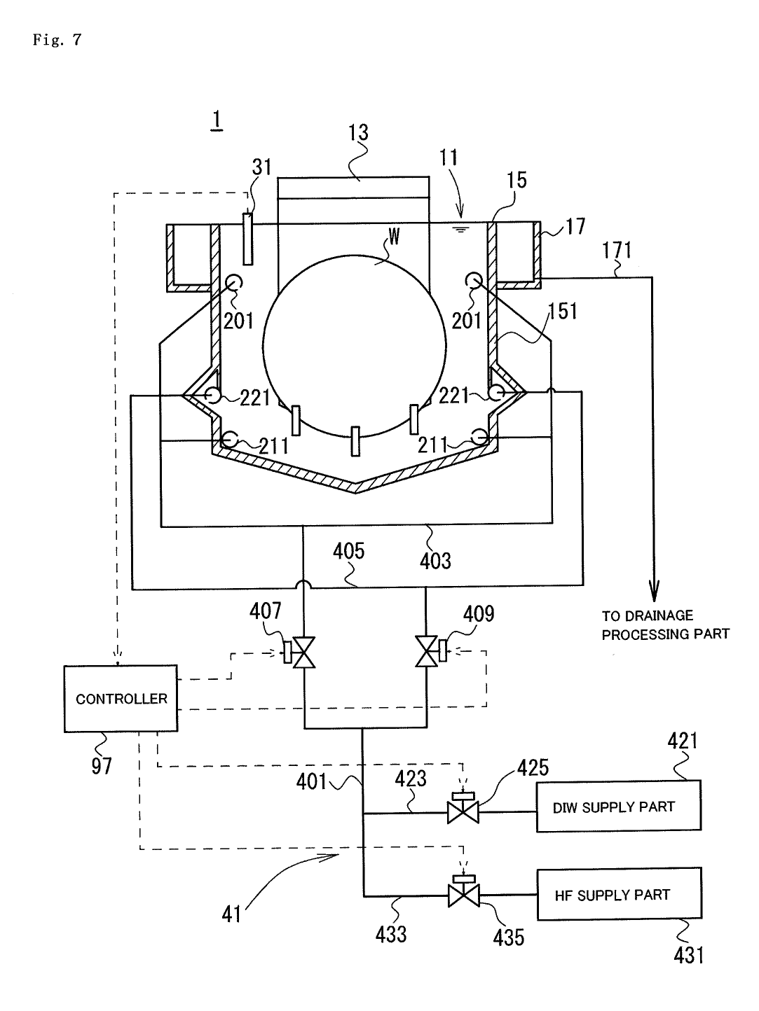

Next, the configuration of the processing bath 11 will be described with reference to FIGS. 4 to 7. FIG. 4 is a vertical sectional view of the processing bath 11 taken along a plane parallel to the main surfaces of the substrates W. FIG. 5 is a vertical sectional view of the processing bath 11 taken along a plane perpendicular to the main surfaces of the substrates W. FIG. 6 is a view showing a flow of the processing liquid when the processing liquid is discharged from third discharge nozzles 221 to be described latter. FIG. 7 is a view showing the configuration of the processing liquid supply part 41.

The processing bath 11 is a reservoir vessel made of quartz or a chemical-resistant resin. The processing bath 11 has an inner bath 15 and an outer bath 17. The inner bath 15 stores the processing liquid therein to immerse substrates W in the processing liquid stored therein. The outer bath 17 is formed on the outer periphery of the inner bath 15. The inner bath 15 includes a bottom wall 153, a pair of short side walls 152, and a pair of long side walls 151. The bottom wall 153 is positioned under the substrates W immersed in the processing liquid. The bottom wall 153 is of a generally V-shaped configuration opening (or facing) upward. The pair of short side walls 152 are positioned lateral to the substrates W and parallel to the main surfaces of the substrates W, with the substrates W therebetween. The pair of long side walls 151 are positioned perpendicularly to the main surfaces of the substrates W (parallel to a direction in which the substrates W held by the lifter 13 are arranged), with the substrates W therebetween. The short side walls 152 and the long side walls 151 correspond to side walls according to the present invention. It should be noted the inner bath 15 has an open top portion.

A pair of first discharge nozzles 201 which are hollow tubular members are fixed near the top portion of the inner bath 15 (in a position above the centers of the substrates W immersed in the processing liquid and below the level of the liquid of which the inner bath 15 is full). The pair of first discharge nozzles 201 are fixed near the inside of the pair of long side walls 151 opposed to each other, with the substrates W therebetween, and each extend horizontally in the direction in which the substrates W are arranged. Each of the first discharge nozzles 201 has a plurality of discharge openings 203 equally spaced apart from each other. The discharge openings 203 discharge the processing liquid obliquely downwardly toward the substrates W immersed in the processing liquid. The discharge openings 203 are positioned to correspond to the space between adjacent ones of the substrates W held by the lifter 13 and the outside of the opposite outermost ones of the substrates W as seen in the direction in which the substrates W are arranged (in the X directions). When the processing liquid is supplied to the first discharge nozzles 201, the processing liquid is discharged from the discharge openings 203 obliquely downwardly toward the substrates W immersed in the processing liquid within the inner bath 15. The first discharge nozzles 201 are disposed above the third discharge nozzles 221 to be described later. The first discharge nozzles 201 constitute first agitating discharge components according to the present invention.

A pair of second discharge nozzles 211 which are hollow tubular members are fixed near the bottom wall 153 of the inner bath 15. The pair of second discharge nozzles 211 are fixed near the inside of the pair of long side walls 151 opposed to each other, with the substrates W therebetween, and each extend horizontally in the direction in which the substrates W are arranged. Each of the second discharge nozzles 211 has a plurality of discharge openings 213 equally spaced apart from each other. The discharge openings 213 discharge the processing liquid obliquely upwardly toward the substrates W immersed in the processing liquid. The discharge openings 213 are positioned to correspond to the space between adjacent ones of the substrates W held by the lifter 13 and the outside of the opposite outermost ones of the substrates W as seen in the direction in which the substrates W are arranged (in the X directions). When the processing liquid is supplied to the second discharge nozzles 211, the processing liquid is discharged from the discharge openings 213 obliquely upwardly toward the substrates W immersed in the processing liquid within the inner bath 15. The second discharge nozzles 211 are disposed below the third discharge nozzles 221 to be described later. The second discharge nozzles 211 constitute second agitating discharge components according to the present invention.

The first discharge nozzles 201 and the second discharge nozzles 211 constitute an agitating discharge part according to the present invention.

Grooves 16 are formed in the respective long side walls 151. The grooves 16 are positioned below the first discharge nozzles 201, above the second discharge nozzles 211 and below the centers of the substrates W immersed in the processing liquid. Each of the grooves 16 is a groove of a V-shaped cross-sectional configuration opening to (or facing toward) the inside of the inner bath 15. The grooves 16 in the respective long side walls 151 extend in a horizontal direction. Specifically, each of the grooves 16 has an planar upper tapered surface 161 and a planar lower tapered surface 163 which are approximately equal in length or dimension as measured in the X directions to the long side walls 151. The upper tapered surface 161 and the lower tapered surface 163 are joined to each other so as to have a common long side. The upper tapered surface 161 and the lower tapered surface 163 are provided in such a manner that the joined long side thereof protrudes outwardly of the inner bath 15 (with the V-shaped cross-sectional configuration opening to (or facing toward) the inside of the inner bath 15). The grooves 16 correspond to recessed portions according to the present invention.

The third discharge nozzles 221 are disposed near the openings of the respective grooves 16 which face toward the inside of the inner bath 15. The third discharge nozzles 221 are fixed along the pair of long side walls 151 opposed to each other, with the substrates W therebetween, and each extend horizontally. Each of the third discharge nozzles 221 has a plurality of discharge openings 223. The discharge openings 223 discharge the processing liquid toward the lower tapered surfaces 163 of the respective grooves 16. The discharge openings 223 are arranged in a horizontal direction along the grooves 16. The discharge openings 223 are positioned to correspond to the space between adjacent ones of the substrates W in the processing bath 11 and the outside of the opposite outermost ones of the substrates W as seen in the X directions. When the processing liquid is supplied to the third discharge nozzles 221, the processing liquid is discharged from the discharge openings 223 of the third discharge nozzles 221 toward the lower tapered surfaces 163 of the grooves 16. That is, the third discharge nozzles 221 discharge the processing liquid obliquely downwardly toward the inside of the grooves 16. The third discharge nozzles 221 correspond to discharge parts according to the present invention.

Plate-like members 18 are mounted to extend between the vicinity of the upper ends of the upper tapered surfaces 161 of the grooves 16 and the third discharge nozzles 221, respectively. The plate-like members 18 close the openings of the grooves 16 lying over the third discharge nozzles 221, respectively. The plate-like members 18 may be formed integrally with the processing bath 11 or be separate members mounted to the processing bath 11. Preferably, the plate-like members 18 extend in the X directions from the position corresponding to the outermost one of the discharge openings 223 as seen in the positive X direction in the third discharge nozzles 221 to the position corresponding to the outermost one of the discharge openings 223 as seen in the negative X direction in the third discharge nozzles 221.

FIG. 6 is an enlarged view of a region X enclosed by dash-dot lines in FIG. 4. A flow of the processing liquid discharged from one of the third discharge nozzles 221 is schematically shown in FIG. 6. A flow near one of the third discharge nozzles 221 and a flow near the other third discharge nozzle 221 are in a mirror-image relationship. Thus, a flow of the processing liquid discharged from the right-hand third discharge nozzle 221 shown in FIG. 4 will be described as a representative.

The processing liquid discharged from the third discharge nozzle 221 impinges upon the lower tapered surface 163 of the groove 16 to turn toward the inside of the inner bath 15 while being diffused along the lower tapered surface 163. The diffused processing liquid forms a thick low-speed liquid flow F11 which in turn reaches the middle position of the bottom of the inner bath 15 and impinges upon a flow of the processing liquid discharged from the opposite third discharge nozzle 221. Thus, the processing liquid turns upwardly of the inner bath 15 to rise slowly. Then, the processing liquid overflows out of the inner bath 15 into the outer bath 17.

A resistivity meter 31 for measuring the resistivity value of the processing liquid is provided within the inner bath 15. The resistivity meter 31 includes a pair of metal electrodes, and measures an electrical resistance between the metal electrodes to measure the resistivity value of the processing liquid. During the process of replacing the processing liquid to be described later, the resistivity meter 31 measures the resistivity value of the processing liquid stored within the processing bath 11 to send acquired information about the resistivity value to the controller 97. The resistivity meter 31 may incorporate a temperature sensor in the metal electrodes to send an equivalent of the resistivity value at a predetermined temperature to the controller 97.

The lifter 13 is a transport mechanism for moving the substrates W upwardly and downwardly between the inside of the inner bath 15 and a position lying over the processing bath 11 while holding the substrates W. The lifter 13 includes three holding rods 131 extending in the direction in which the substrates W are arranged. Each of the holding rods 131 has a plurality of holding grooves formed therein although not shown. The substrates W are held in parallel with each other in an upright position on the three holding rods 131, with peripheral portions of the respective substrates W fitted in the holding grooves. The lifter 13 is connected to a driver 135 via a shaft 133. The driver 135 is constructed by a known mechanism including a motor, a ball screw and the like combined together. When the driver 135 is brought into operation, the lifter 13 moves upwardly and downwardly. This transports the substrates W between an immersed position inside the inner bath 15 (a position in which the substrates W are completely immersed in the processing liquid stored in the inner bath 15) and a raised position over the processing bath 11 (a position in which the substrates W are completely exposed outside the processing liquid stored in the inner bath 15). The lifter 13 and the driver 135 correspond to a holding part according to the present invention.

Next, the processing liquid supply part 41 will be described with reference to FIG. 7. FIG. 7 is a view showing the configuration of the processing liquid supply part 41. The processing liquid supply part 41 includes a DIW supply part 421 and a HF supply part 431. The DIW supply part 421 supplies deionized water (referred to as “DIW” hereinafter) serving as a processing liquid to the processing bath 11. The HF supply part 431 supplies hydrofluoric acid (referred to as “HF” hereinafter) serving as a processing liquid to the processing bath 11.

The DIW supply part 421 is connected to a first end of a pipe 423. The pipe 423 has a second end connected to a collecting pipe 401. An on-off valve 425 is interposed in the pipe 423. The on-off valve 425 is normally closed. The on-off valve 425 is electrically connected to the controller 97. It should be noted that the DIW supply part 421 may be provided either inside or outside the substrate processing apparatus 9. The DIW supply part 421 may be configured to include a tank for storing DIW therein or to receive DIW supplied directly from a utility system in a factory.

The HF supply part 431 is connected to a first end of a pipe 433. The pipe 433 has a second end connected to the collecting pipe 401. An on-off valve 435 is interposed in the pipe 433. The on-off valve 435 is normally closed. The on-off valve 435 is electrically connected to the controller 97. It should be noted that the HF supply part 431 may be provided either inside or outside the substrate processing apparatus 9. The HF supply part 431 may be configured to include a tank for storing HF therein or to receive HF supplied directly from a utility system in a factory.

The collecting pipe 401 is divided into two branches which in turn are connected to a first branch pipe 403 and a second branch pipe 405, respectively. On-off valves 407 and 409 are interposed in the two branches, respectively, of the collecting pipe 401. The on-off valves 407 and 409 are normally closed. The on-off valves 407 and 409 are electrically connected to the controller 97.

The first branch pipe 403 is connected to the two first discharge nozzles 201 disposed near the upper portions of the two long side walls 151 of the inner bath 15 and to the two second discharge nozzles 211 disposed near the lower portions thereof. The second branch pipe 405 is connected to the two third discharge nozzles 221 disposed near the grooves 16 provided in the two long side walls 151 of the inner bath 15.

When the controller 97 provides an operating instruction to the on-off valve 425 to open the on-off valve 425, the supply of DIW from the DIW supply part 421 is started. When the controller 97 provides an operating instruction to the on-off valve 407 to open the on-off valve 407 at this time, the DIW is supplied from the DIW supply part 421 via the pipe 423, the collecting pipe 401 and the first branch pipe 403 to the first discharge nozzles 201 and the second discharge nozzles 211. Then, the DIW is discharged from the first discharge nozzles 201 and the second discharge nozzles 211 into the inner bath 15.

When the controller 97 provides an operating instruction to the on-off valve 409 to open the on-off valve 409 at the instant when the supply of the DIW from the DIW supply part 421 is started, the DIW is supplied from the DIW supply part 421 via the pipe 423, the collecting pipe 401 and the second branch pipe 405 to the third discharge nozzles 221. Then, the DIW is discharged from the third discharge nozzles 221 into the inner bath 15. It should be noted that the on-off valve 407 and the on-off valve 409 are selectively opened.

When the controller 97 provides an operating instruction to the on-off valve 435 to open the on-off valve 435, the supply of HF from the HF supply part 431 is started. When the controller 97 provides an operating instruction to the on-off valve 407 to open the on-off valve 407 at this time, the HF is supplied from the HF supply part 431 via the pipe 433, the collecting pipe 401 and the first branch pipe 403 to the first discharge nozzles 201 and the second discharge nozzles 211. Then, the HF is discharged from the first discharge nozzles 201 and the second discharge nozzles 211 into the inner bath 15.

When the controller 97 provides an operating instruction to the on-off valve 409 to open the on-off valve 409 at the instant when the supply of the HF from the HF supply part 431 is started, the HF is supplied from the HF supply part 431 via the pipe 433, the collecting pipe 401 and the second branch pipe 405 to the third discharge nozzles 221. Then, the HF is discharged from the third discharge nozzles 221 into the inner bath 15.

In other words, the on-off valve 407 and the on-off valve 409 constitute a switching part for switching between the discharge of the processing liquid from the third discharge nozzles 221 and the discharge of the processing liquid from the first discharge nozzles 201 and the second discharge nozzles 211.

The outer bath 17 is connected to a first end of a pipe 171. The pipe 171 has a second end connected to a drainage processing part not shown. The processing liquid overflowing out of the inner bath 15 is received by the outer bath 17, and is then delivered via the pipe 171 to the drainage processing part. Processes related to the recycling and disposal of the processing liquid are performed in the drainage processing part.

The controller 97 includes a CPU, a ROM, a RAM, and a magnetic disk. The CPU performs various computation processes. The ROM is a read-only memory for storing a basic program therein. The RAM is a readable/writable memory for storing various pieces of information therein. The magnetic disk stores control software, data and the like therein. Processing conditions depending on the substrates W are previously stored as a processing program (known also as a recipe) in the magnetic disk. The CPU reads descriptions of the processing program onto the RAM, and controls the components of the substrate processing apparatus 9 in accordance with the descriptions of the processing program read onto the RAM.

### 2. Operation of Substrate Processing Apparatus

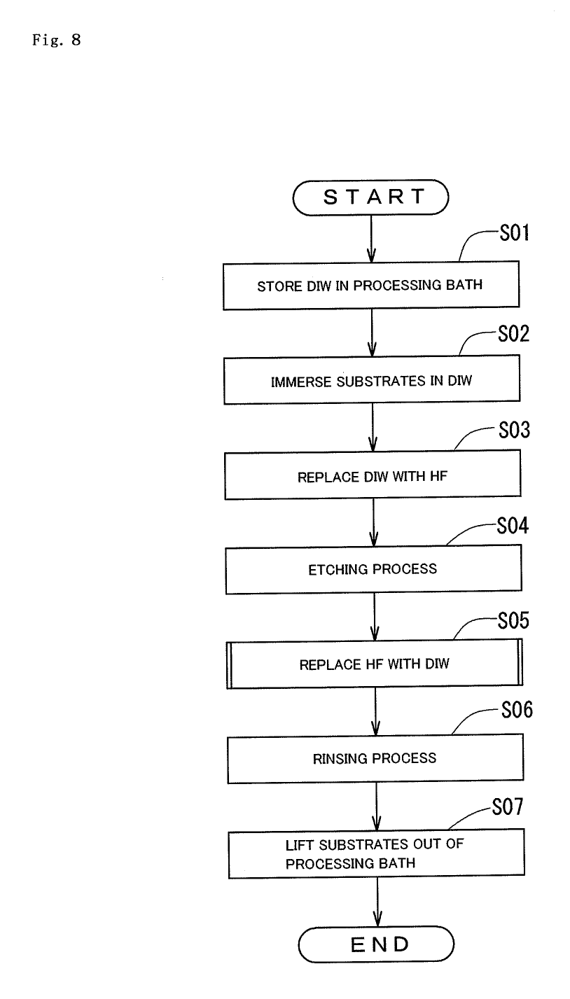

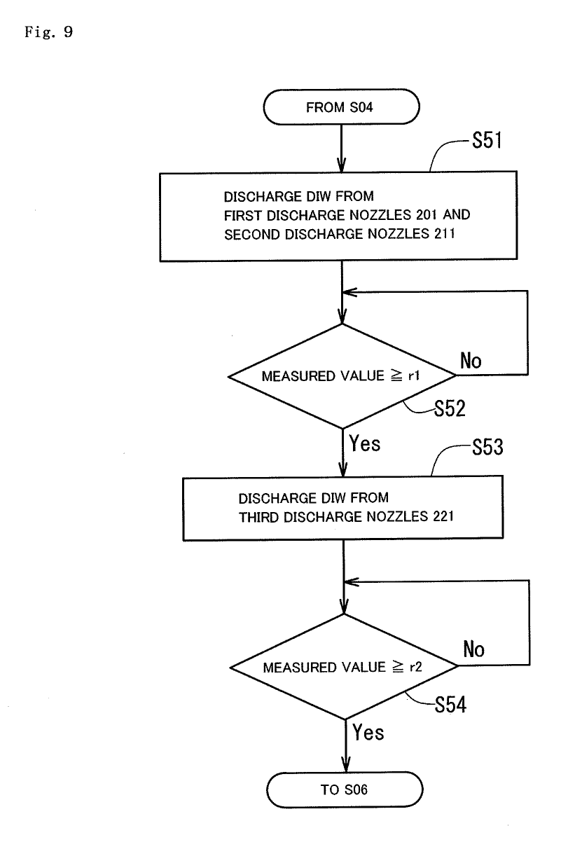

Next, the operation of the substrate processing apparatus 9 during the processing of the substrates W in the aforementioned processing unit 10 will be described with reference to flow diagrams shown in FIGS. 8 and 9.

For the processing of the substrates W in the processing unit 10, the controller 97 initially provides an operating instruction to close the on-off valve 407 and to open the on-off valve 409 and the on-off valve 425. Thus, the DIW is supplied from the DIW supply part 421 via the pipe 423, the collecting pipe 401 and the second branch pipe 405 to the third discharge nozzles 221. Then, the DIW is discharged from the third discharge nozzles 221 into the inner bath 15. The DIW is gradually stored within the inner bath 15, and then overflows from the top of the inner bath 15 into the outer bath 17 (in Step S01). The DIW overflowing into the outer bath 17 is drained via the pipe 171 to the drainage processing part.

Next, the substrates W transported via the cassette rest part 91, the substrate transfer part 92 and the substrate transport part 93 are placed onto the lifter 13 waiting in the raised position lying over the processing bath 11. After the substrates W are placed on the lifter 13, the controller 97 provides an operating instruction to the driver 135 to bring the driver 135 into operation, thereby moving the lifter 13 downwardly to the immersed position. Thus, the substrates W are immersed in the DIW stored within the inner bath 15 (in Step S02).

Subsequently, the controller 97 provides an operating instruction to close the on-off valve 409 and the on-off valve 425 and to open the on-off valve 407 and the on-off valve 435. Thus, the HF is supplied from the HF supply part 431 via the pipe 433, the collecting pipe 401 and the first branch pipe 403 to the first discharge nozzles 201 and the second discharge nozzles 211. Then, the HF is discharged from the first discharge nozzles 201 and the second discharge nozzles 211 into the inner bath 15. In this manner, the processing liquid is caused to overflow from the top of the inner bath 15 into the outer bath 17 while the HF is supplied into the inner bath 15, whereby the DIW is gradually replaced with the HF within the inner bath 15 (in Step S03).

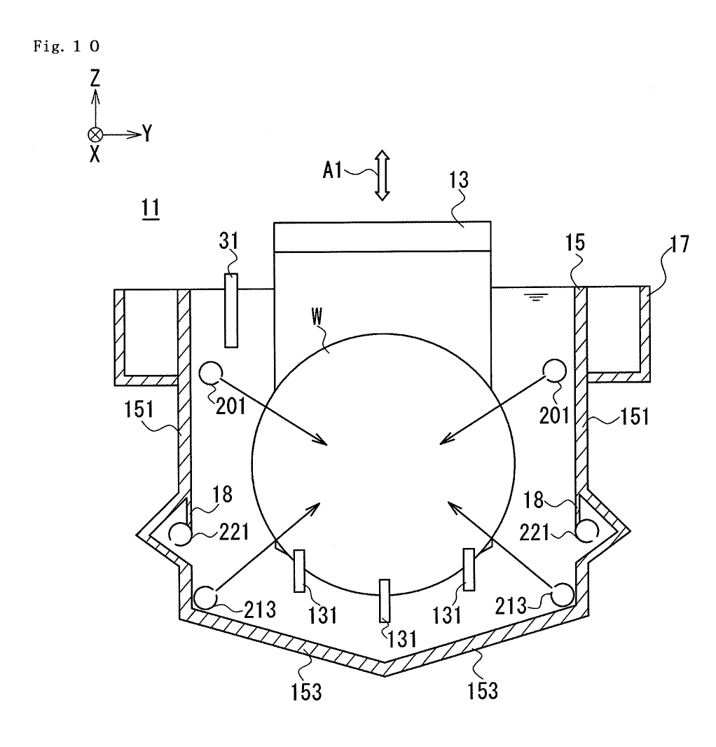

The start of the replacement of the DIW to the HF causes the HF supplied to near the main surfaces of the substrates W to start the process of etching the substrates W. The HF is discharged from the first discharge nozzles 201 and the second discharge nozzles 211 disposed on opposite sides of the inner bath 15 toward the inside of the inner bath 15 to form relatively high-speed liquid flows within the inner bath 15, as shown in FIG. 10. This causes the HF supplied to the inside of the inner bath 15 to be agitated widely all over the inside of the inner bath 15. Thus, in the course of the replacement of the DIW with the HF, the concentration of the HF is always made uniform within the inner bath 15. As a result, the etching process is performed uniformly on the entire main surfaces of the substrates W.

Referring again to FIG. 8, after the completion of the replacement of the DIW with the HF, the discharge of the HF from the first discharge nozzles 201 and the second discharge nozzles 211 is continued, as required. The substrates W immersed in the HF stored in the inner bath 15 continue to be subjected to the etching process (in Step S04).

Next, the HF is replaced with the DIW within the inner bath 15 (in Step S05). A detailed procedure for the process of replacing the HF with the DIW in Step S05 will be described with reference to the flow diagram of FIG. 9.

For the replacement of the HF with the DIW within the inner bath 15, the controller 97 initially provides an operating instruction to close the on-off valve 435 and to open the on-off valve 425. It should be noted that the on-off valve 409 is maintained closed and the on-off valve 407 is maintained open. Thus, the DIW is supplied from the DIW supply part 421 via the pipe 423, the collecting pipe 401 and the first branch pipe 403 to the first discharge nozzles 201 and the second discharge nozzles 211. Then, the DIW is discharged from the first discharge nozzles 201 and the second discharge nozzles 211 into the inner bath 15. In this manner, the processing liquid is caused to overflow from the top of the inner bath 15 into the outer bath 17 while the DIW is supplied into the inner bath 15, whereby the HF is gradually replaced with the DIW within the inner bath 15 (in Step S51).

In the early stage of the replacement of the HF with the DIW, the HF remaining within the inner bath 15 causes the etching process of the substrates W to still proceed. In this early stage of the replacement, the DIW is discharged from the first discharge nozzles 201 and the second discharge nozzles 211 to form relatively high-speed liquid flows within the inner bath 15, as shown in FIG. 10. This causes the HF remaining within the inner bath 15 to be agitated widely all over the inside of the inner bath 15. As a result, the etching process is performed uniformly on the entire main surfaces of the substrates W.

Referring again to FIG. 9, as the replacement of the HF with the DIW proceeds, the concentration of the HF in the processing liquid stored within the inner bath 15 decreases gradually. As the concentration of the HF decreases, the value measured with the resistivity meter 31 increases gradually. The controller 97 receives the value measured with the resistivity meter 31 to continuously monitor whether or not the measured value reaches a predetermined reference value r1 (in Step S52). The reference value r1 used herein is a resistivity value of the processing liquid such that the HF in the processing liquid no longer causes the etching process of the substrates W to substantially proceed. The reference value r1 is previously set in the controller 97 based on a previous experiment and the like.

When the value measured with the resistivity meter 31 reaches the aforementioned reference value r1, the controller 97 provides an operating instruction to close the on-off valve 407 and to open the on-off valve 409. This stops the discharge of the DIW from the first discharge nozzles 201 and the second discharge nozzles 211, and starts the discharge of the DIW from the third discharge nozzles 221 (in Step S53).

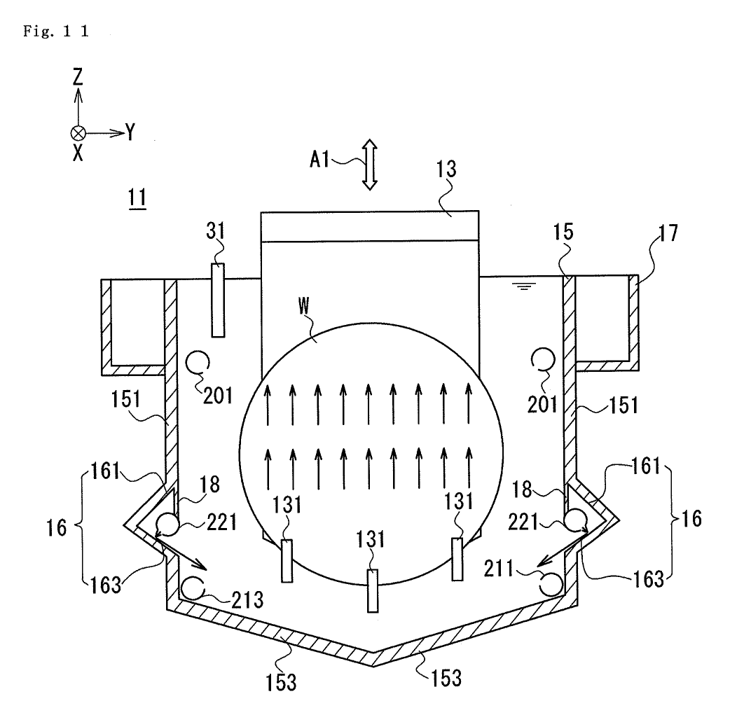

The DIW discharged from the third discharge nozzles 221 impinges upon the grooves 16 formed in the long side walls 151 of the inner bath 15 to diffuse, thereby moving toward the vicinity of the middle of the bottom portion of the inner bath 15. Thus, low-speed uniform liquid flows directed upwardly from near the bottom portion of the inner bath 15 are formed within the inner bath 15, as shown in FIG. 11. Accordingly, the HF remaining within the inner bath 15 is drained from the top portion of the inner bath 15 into the outer bath 17 in such a manner as to be forced out by the low-speed flows of the DIW. As a result, the replacement of the HF with the DIW proceeds efficiently within the inner bath 15.

In Step S53, the DIW is discharged from the third discharge nozzles 221 toward the grooves 16 formed in the inner surfaces of the long side walls 151. The DIW impinges upon the lower tapered surfaces 163 of the grooves 16 to divide into upward and downward flows. The flows of the DIW directed upwardly of the third discharge nozzles 221 are blocked by the plate-like members 18. Thus, the flows of the DIW directed upwardly from the bottom portion of the inner bath 15 are less disturbed near the upper portions of the grooves 16. In other words, the DIW directed from the grooves 16 toward the bottom wall 153 flows more uniformly upwardly from the bottom portion of the inner bath 15. As a result, the replacement of the HF with the DIW proceeds more efficiently within the inner bath 15.

Referring again to FIG. 9, the controller 97 continues to receive the value measured with the resistivity meter 31 to continuously monitor whether or not the measured value reaches a predetermined reference value r2 (in Step S54). The reference value r2 used herein is a resistivity value of the processing liquid such that the HF in the processing liquid is judged to be almost completely drained and be almost completely replaced with the DIW within the inner bath 15. The reference value r2 is previously set in the controller 97. When the resistivity value measured with the resistivity meter 31 reaches the reference value r2, the procedure proceeds to the subsequent step, i.e., Step S06.

Referring again to FIG. 8, the controller 97 continues the discharge of the DIW from the third discharge nozzles 221, as required, after the value measured with the resistivity meter 31 reaches the aforementioned reference value r2. Thus, the substrates W immersed in the DIW stored in the inner bath 15 are subjected to a rinsing process with the DIW (in Step S06).

Thereafter, the controller 97 provides an operating instruction to the driver 135 to move the lifter 13 upwardly to the raised position, thereby lifting the substrates W out of the inner bath 15 (in Step S07). Thus, the process performed on the substrates W in a set in the processing unit 10 is completed.

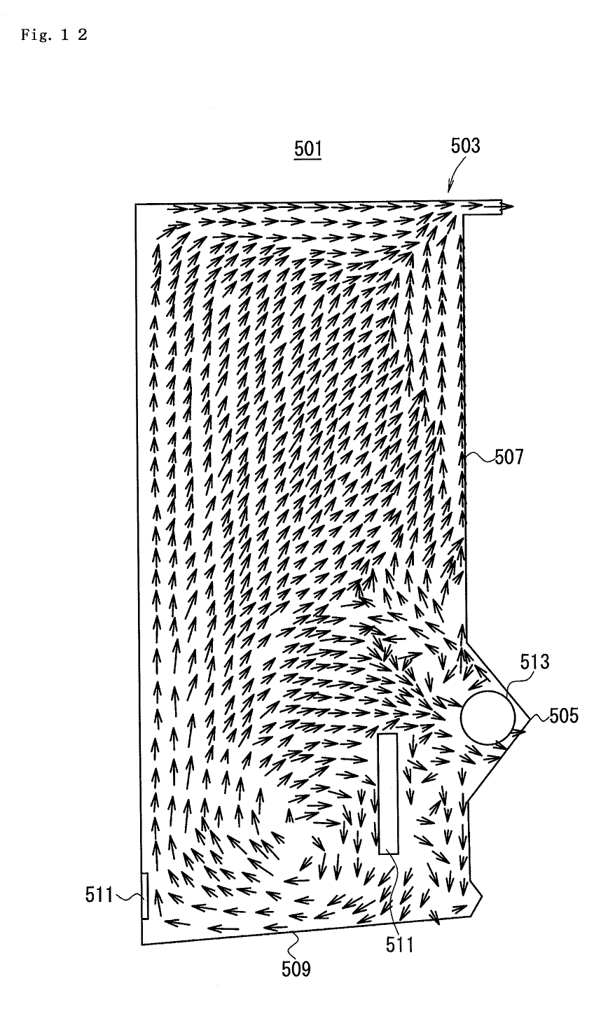

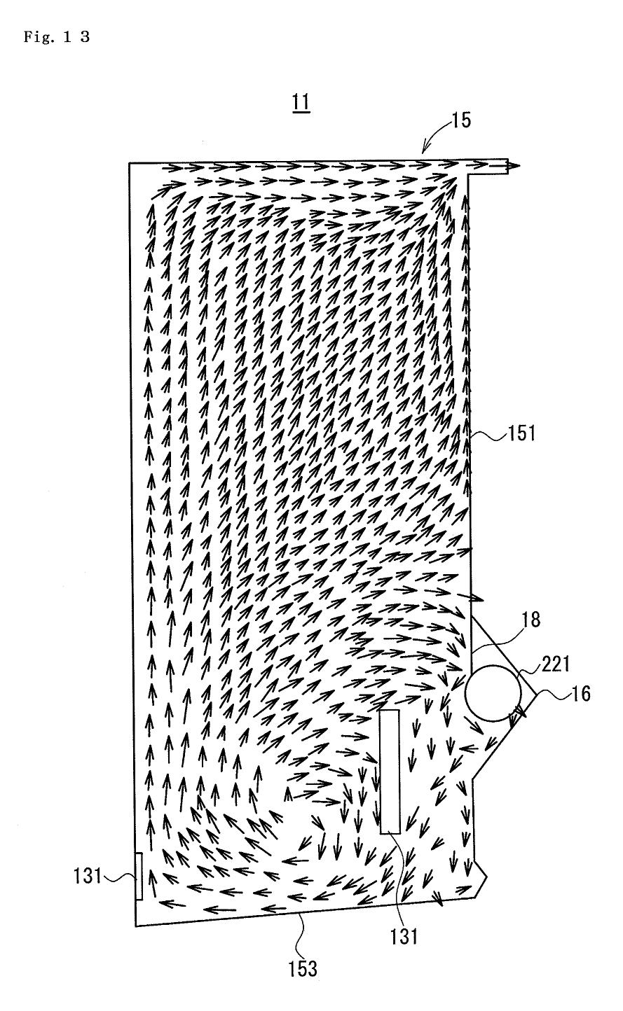

FIG. 12 shows a result of a simulation of flows of the processing liquid during the replacement of the processing liquid (during the discharge of the processing liquid from the discharge nozzle 513) in the processing bath 503 disclosed in Japanese Patent Application Laid-Open No. 2009-81240. FIG. 13 shows a result of a simulation of flows of the processing liquid during the replacement of the processing liquid (during the discharge of the processing liquid from the third discharge nozzles 221, which corresponds to Step S53 described above) in the inner bath 15 according to the present preferred embodiment. In FIGS. 12 and 13, the results of simulations using general-purpose fluid analysis software are shown in schematic form. The results show that turbulence in the flows of the processing liquid which has been created around an area on the upper-left of the discharge nozzle 513 in FIG. 12 is eliminated in FIG. 13, and that flows of the processing liquid directed substantially upwardly in the inner bath 15 are generally formed in FIG. 13. It is hence understood that flows which allow the efficient replacement of the processing liquid are generated in FIG. 13.

### 3. Modifications

While the one preferred embodiment according to the present invention has been described hereinabove, the present invention is not limited to the aforementioned preferred embodiment. For example, each of the grooves 16 according to the aforementioned preferred embodiment is a groove of a V-shaped cross-sectional configuration defined by the upper tapered surface 161 and the lower tapered surface 163. The configuration of the grooves 16, however, may be other configurations than the V-shaped cross-sectional configuration, such as a polygonal configuration and a curved surface (semicylindrical) configuration.

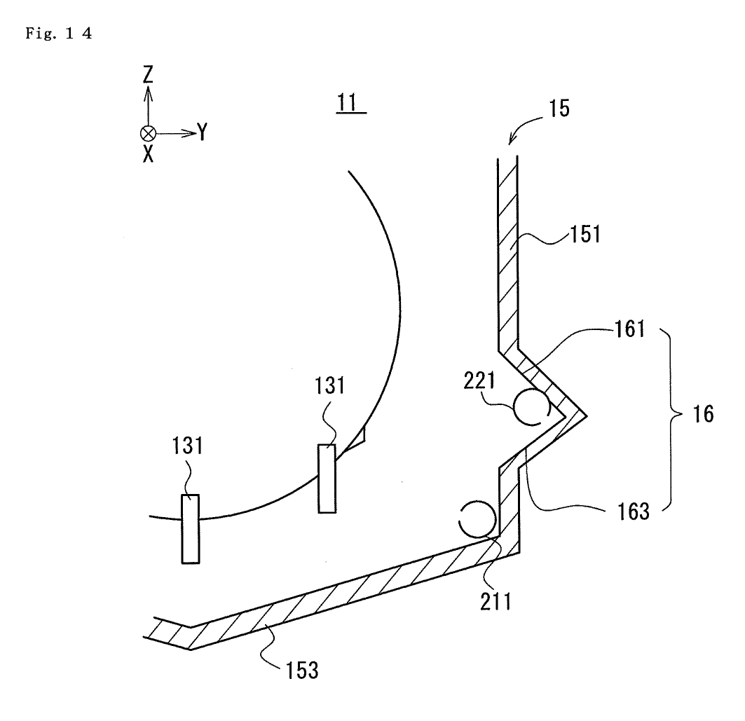

In the aforementioned preferred embodiment, the plate-like members 18 extend from near the upper ends of the upper tapered surfaces 161 of the grooves 16 to the third discharge nozzles 221, respectively. Alternatively, each of the third discharge nozzles 221 may be configured to be in contact with or be buried in the upper tapered surface 161 of the groove 16, as shown in FIG. 14. In this case, the processing liquid is discharged from the third discharge nozzle 221 toward the groove 16, and then divides into upward and downward flows. The upward flows of the processing liquid are blocked by the third discharge nozzle 221 itself. Thus, the flows of the processing liquid directed upwardly from the bottom portion of the inner bath 15 are restrained from being disturbed near the upper portion of the groove 16.

Although HF and DIW are used as the processing liquid in the aforementioned preferred embodiment, the substrate processing apparatus according to the present invention may use other processing liquids to process the substrates W. Also, the present invention is applicable not only to a substrate processing apparatus which processes semiconductor substrates but also to substrate processing apparatuses which process various substrates such as glass substrates for a liquid crystal display device, glass substrates for a photomask and the like.

While the invention has been described in detail, the foregoing description is in all aspects illustrative and not restrictive. It is understood that numerous other modifications and variations can be devised without departing from the scope of the invention.

What is claimed is:

1. A substrate processing apparatus comprising:
a processing bath having side walls and a bottom wall for storing a processing liquid therein;
a pair of recessed portions formed respectively in a pair of opposed ones of the side walls of said processing bath, said recessed portions being disposed near the bottom wall, each of said recessed portions having an opening facing toward the inside of said processing bath;
a pair of discharge parts for discharging the processing liquid toward the inside of said recessed portions, respectively; and
a pair of plate-like members coupling the vicinity of the upper ends of said recessed portions and said discharge parts, respectively.

2. The substrate processing apparatus according to claim 1, wherein:
said recessed portions are grooves extending in a horizontal direction along said pair of opposed side walls, respectively;
each of said discharge parts has a plurality of discharge openings arranged in a horizontal direction along a corresponding one of said grooves; and
each of said plate-like members extends from a position corresponding to an outermost one of the discharge openings on a first end thereof to a position corresponding to an outermost one of the discharge openings on a second end thereof.

3. A substrate processing apparatus comprising:
a processing bath having side walls and a bottom wall for storing a processing liquid therein;
a pair of recessed portions formed respectively in a pair of opposed ones of the side walls of said processing bath, said recessed portions being disposed near the bottom wall, each of said recessed portions having an opening facing toward the inside of said processing bath; and
a pair of discharge parts for discharging the processing liquid toward the inside of said recessed portions, respectively,
said discharge parts being in contact with or being buried in upper halves of said recessed portions, respectively.

4. The substrate processing apparatus according to claim 1, wherein
said discharge parts discharge the processing liquid obliquely downwardly toward the inside of said recessed portions, respectively.

5. The substrate processing apparatus according to claim 4, wherein:
each of said recessed portions is a groove of a V-shaped cross-sectional configuration opening to the inside of said processing bath, the groove being defined by a pair of tapered surfaces; and
each of the discharge parts discharges the processing liquid toward a lower one of the tapered surfaces of the groove.

6. The substrate processing apparatus according to claim 1, further comprising:
an agitating discharge part for discharging the processing liquid toward a substrate within said processing bath; and
a switching part for switching between the discharge of the processing liquid from said pair of discharge parts and the discharge of the processing liquid from said agitating discharge part.

7. The substrate processing apparatus according to claim 6, wherein
said agitating discharge part includes:
a pair of first agitating discharge components disposed above said pair of discharge parts; and
a pair of second agitating discharge components disposed below said pair of discharge parts.

8. A method of performing a process using a processing liquid on a substrate, comprising the steps of:
a) immersing a substrate in a processing liquid within a processing bath having a side wall and a bottom wall; and
b) discharging the processing liquid from a nozzle toward a recessed portion provided in an inner surface of said side wall, while blocking a flow of the processing liquid directed from the inside of said recessed portion upwardly of said nozzle, thereby forming a flow of the processing liquid directed from said recessed portion toward said bottom wall.

9. The method according to claim 8, wherein
the flow of the processing liquid directed from the inside of said recessed portion upwardly of said nozzle is blocked by a plate-like member coupling the vicinity of an upper end of said recessed portion and said nozzle in said step b).

10. The method according to claim 8, wherein:
said nozzle is in contact with or is buried in an upper half of said recessed portion; and
the flow of the processing liquid directed from the inside of said recessed portion upwardly of said nozzle is blocked by said nozzle in said step b).
